(19) United States
(12) Patent Application Publication
(10) Pub. No.: US 2010/0106487 A1
(43) Pub. Date: Apr. 29, 2010

(54) Style-checking method and apparatus for business writing

(76) Inventors: Linda B. Vanderwold, Dixon, CA (US); Donald L. Hallberg, Davis, CA (US)

Correspondence Address: Audrey A. Millemann;Weintraub Genshlea Chediak, 11th Floor, 400 Capitol Mall, Sacramento, CA, 95814, US

(21) Appl. No.: 12/653,884

(22) Filed: Dec. 18, 2009

Related U.S. Application Data
(63) Continuation of application No. 12/148,265, filed on Apr. 14, 2008, now abandoned.
Application No. 12/148,265 is a division of application No. 09/454,173, filed on Dec. 2, 1999, now abandoned.

(51) Int. Cl. G06F 17/27

(52) U.S. Cl. 704/9; 704/E11.001

(57) ABSTRACT

The method is software-based, and carried out on a computer system and cooperating apparatus. It checks written text for problems impairing clarity, conciseness and reader comfort in business documents. One embodiment includes routines for checking writing style in sentences and paragraphs, and for generating informational, critical and commendatory display indicators relating to reader comfort. The routines check subject and verb juxtaposition, verb strength, prepositional phrase use, transition words, unity-creating constructions, gerund use, and sentence variety. The indicators are displayed in the form of highlighted text and diacritical marks. Another embodiment is a method for quantifying reader discomfort. It includes routines for quantifying, reporting and displaying points indicating comfort-impairing problems of the type located by running the routines of the first embodiment. Yet another embodiment includes a method for editing text documents for reader comfort, by locating and fixing problem words and constructions.

### CROSS-REFERENCE TO RELATED APPLICATION

This application is a continuation of prior U.S. application Ser. No. 12/148,265 filed on Apr. 14, 2008 which was a divisional application of prior U.S. application Ser. No. 09/454,173 filed on Dec. 2, 1999, pursuant to 35 U.S.C. §120, and hereby incorporates those applications in their entirety by reference.

### BACKGROUND OF THE INVENTION

1. Field of the Invention

The present invention relates generally to methods and apparatus for improving literacy, and more specifically to methods and apparatus for checking, editing and teaching particular writing styles.

2. Description of the Related Art

Writers commonly use dictionaries, thesauri, grammar guides, and word processor-based spelling and grammar checkers to assure writing is technically correct. And, general style guides offer writers different ways of presenting content. Although these resources are generally sufficient for casual writers, today's business world demands more from its writers than the mere technical precision achievable with conventional aids. Whether in e-mail or an annual report, business writing should be clear and concise. Business writers need to remember that even though a written piece may be grammatically and otherwise correct, it may remain unclear, boring or uncomfortable to read. The message must not get lost in the words.

Constructions that confuse and frustrate readers most include: disconnected subjects and verbs; weak verbs; misused prepositional phrases; repetitive sentence styles; and, too few transitional words and unifying topical links within paragraphs. Such problems are rarely cured by quickly checking a text, or by running a document through a grammar-checking program. And, style guides merely offer a wide collection of subjective tips and pointers, such as “pick the best approach for the audience,” or “break up big ideas for better readability.” Using those resources and methods, unfortunately, merely results in subjective “this sounds better”-type editing, feeding endless rewrite cycles.

Ultimately, what business writers should strive for is best described as “reader comfort.” However, prior-available systems and methods fail to provide clear paths to achieving that goal.

Accordingly, it appears a need exists for an objective method for writing, style-checking and editing business text documents to maximize reader comfort.

### SUMMARY OF THE INVENTION

The method and apparatus of the present invention are adapted to overcome the above-noted shortcomings and to fulfill the stated needs. They are specifically adapted to critiquing and editing business writing, and some types of technical writing, as well.

One embodiment of the invention is a method for style-checking a text document to achieve clarity, conciseness and reader comfort. Therein, a commendatory indicator is displayed if a subject and corresponding verb of a sentence or clause are juxtaposed, while a critical indicator is displayed if the subject and verb are not juxtaposed. Critical indicators are displayed for prepositional phrases and weak verbs; and, commendatory indicators are displayed for strong verbs.

Another embodiment of the invention is a method for quantifying reader discomfort in a text document. It first requires establishment of a scoring baseline. Then, points indicating discomfort are added for: a high ratio of nonjuxtaposed subjects and verbs to juxtaposed subjects and verbs; a high ratio of weak verbs to strong verbs; and, for a high ratio of the number of sentences to the number of transition words in the document.

Yet another embodiment of the invention is a method for editing a text document. It comprises the steps of inputting the document to a computer system; conducting error-correcting functions to achieve clarity, conciseness and reader comfort; and, displaying the document in a corrected form.

The inventive concept also includes apparatus for carrying out the inventive methods on printed documents as well as electronic documents.

One object of the present invention is to provide structured style-checking, editing and drafting methods for writing business documents.

A further object of the present invention is to provide a method for clear, concise business writing, wherein the method is reduced to a logical set of steps and processes.

Yet another object of this invention is to provide business writing methods and apparatus for achieving reader comfort, wherein the methods and apparatus generate objective and measurable results and data useful in, at once, improving the writer's skill, and increasing the reader comfort of a given document.

Still further objects of the inventive method and apparatus disclosed herein will be apparent from the drawings and following detailed description thereof.

### BRIEF DESCRIPTION OF THE DRAWINGS

FIG. 1 is a block diagram of a computer system useable in carrying out the method of the invention.

FIG. 2A is a portion of a flow chart showing the display indicator-generating method portion of the invention.

FIG. 2B is a flow chart continued from FIG. 2A showing a portion of the display indicator-generating method of the invention.

FIG. 2C is a flow chart continued from FIG. 2A showing a portion of the display indicator-generating method of the invention.

FIG. 2D is a flow chart continued from FIG. 2A showing a portion of the display indicator-generating method of the invention.

FIG. 3A is a portion of a flow chart showing the reader discomfort calculating and reporting method of the invention.

FIG. 3B is a flow chart continued from FIG. 3A showing a portion of the reader discomfort calculating and reporting method of the invention.

FIG. 4A is a portion of a flow chart showing the error-correcting method of the invention.

FIG. 4B is a flow chart continued from FIG. 4A showing a portion of the error-correcting method of the invention.

### DESCRIPTION OF THE PREFERRED EMBODIMENT

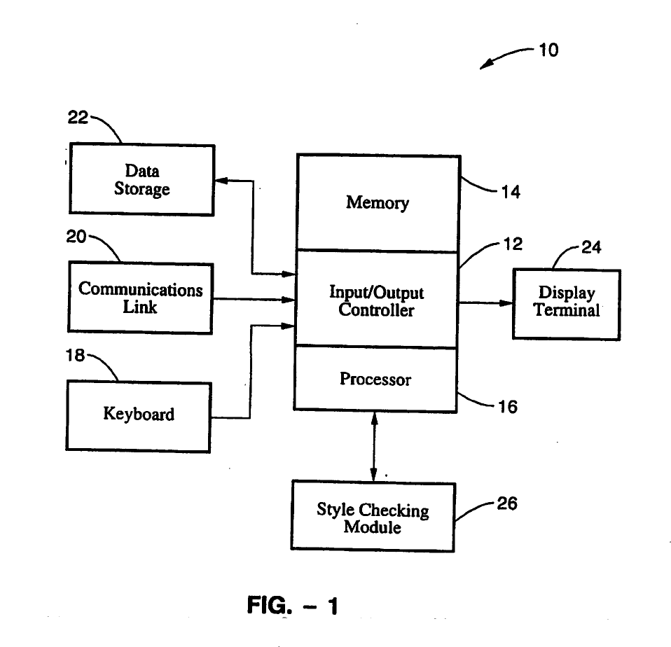

FIG. 1 shows a block diagram of an apparatus, specifically, a stand-alone computer system 10, for carrying out the writing style-checking method of the invention. Computer system 10 includes an input/output controller 12 associated with a memory element 14 and a programmable processor 16. Input/output controller 12 is able to receive input from keyboard 18, or communications link 20, and is able to read and write data to from data storage device 22. A display terminal 24 receives output from input/output controller 12. Style-checking software module 26 may be a separate application program, or may operate through another application, such as, a word processor.

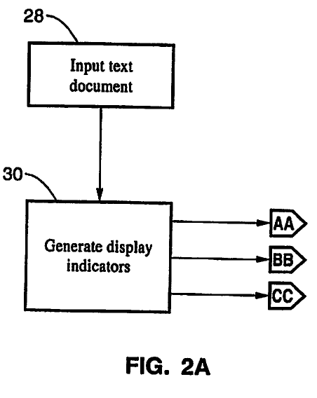

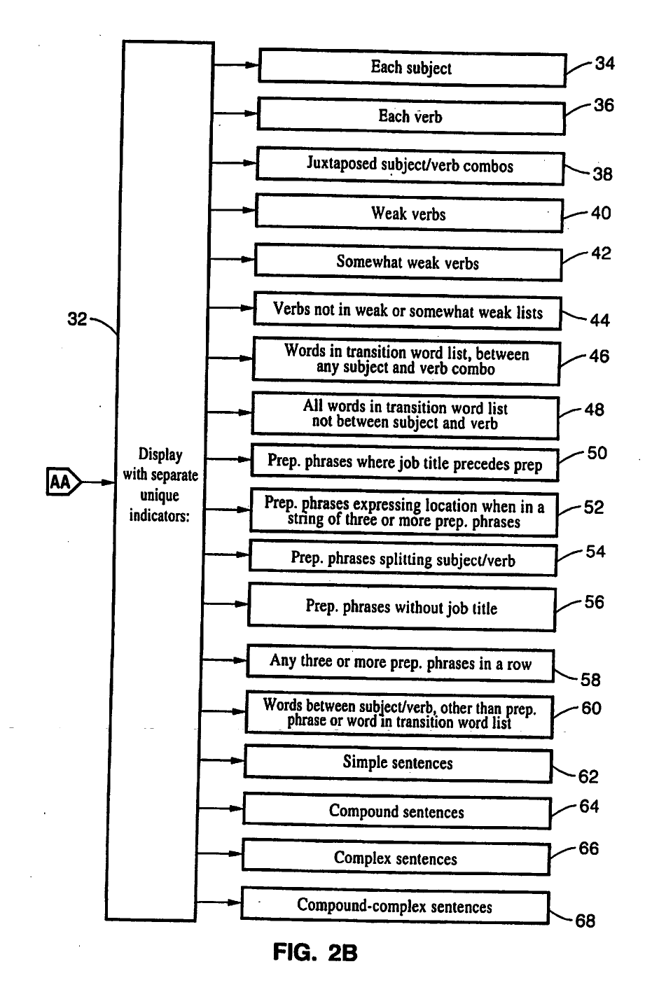

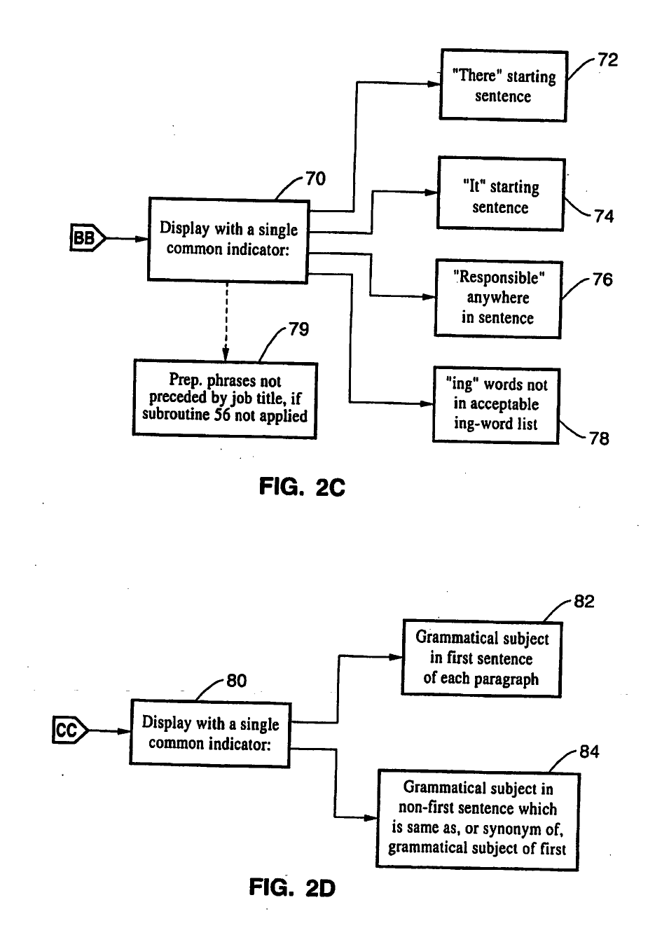

FIGS. 2A-2D illustrate a first embodiment of the invention. Therein, a processing sequence is shown, in a block diagram representation, of a computer-aided method for checking the writing style of sentences and paragraphs in an electronic document for reader comfort. The method of the invention will generally be embodied in and carried out through style-checking computer software module 26. The electronic document will generally be in the form of a business text document file 28 created with a software application program such as a word processor, or other application able to generate the text of a business document.

Delivery, i.e, input, of the text file 28 to the style checker 26 may be from a data storage device 22, or from a communications link 20. Alternatively, text may be input directly from keyboard 18. Other methods of input, such as scanning a hard copy, i.e. a paper-printed copy, of a business text document, are also contemplated, as are other methods known to those having skill in the art.

In generating a display 30, words and word groups in the text are shown on display terminal 24 along with informational, critical or commendatory indicators. This step may include parsing each sentence into its parts of speech and other components: nouns; group nouns; verbs; adverbs; prepositions; prepositional phrases; grammatical subjects; and, the like. Software modules able to perform such parsing functions are well-known in the art. The informational, critical and commendatory display indicators may include various types and colors of underlining, highlighting and diacritical markings in superscripts and subscripts. Although several types of preferred indicators are set forth herein, theses should only be construed to be examples. Any indicators which do not obscure the text may work satisfactorily. The character and meaning of each indicator may be set forth in a separate table, chart, key or set of instructions similar to that set forth farther below.

In a first display routine 32, shown in FIG. 2B, separate unique indicators are displayed with each of several parts of speech, word groups and words in particular positions. No particular order need be followed in generating separate unique display indicators of routine 32.

In one subroutine 34, each subject of a sentence is displayed with an informational indicator, for example, a black underline. If a sentence has multiple subjects, as in a compound sentence, more than one word or word group may be black-underlined.

In a separate subroutine 36, each verb is double-underlined in black. Sentences having multiple verbs will have each double-underlined. This unique display indicator marking verbs as particular parts of speech is informational. Additional indicators, both critical and commendatory, for verbs of different types are set forth, below.

Sentences and clauses are more comfortable to read when their subjects and verbs are juxtaposed, i.e. positioned side by side. Juxtaposing the subject and verb encourages subject-verb agreement. Thus, in a separate subroutine 38, juxtaposed subjects and verbs are displayed with a unique commendatory indicator: pink highlighting.

Weak verbs detract from clarity and reader comfort. They require a great deal of support from other parts of the sentence, thus promoting wordy writing and diminishing readers' abilities to remember the message communicated. Thus, in a separate subroutine 40, weak verbs are given a critical unique display indicator: an orange check mark above the verb. Weak verbs are identified by referring to a weak verb list, including words such as those set forth in the following Table 1:

TABLE 1
Weak Verb List

am
are
be
been
being
can
could
did
do
does
is
had
has
have
may
might
must
shall
should
was
were
will
would

Other verbs such as “seems” and “appears” are considered somewhat weak, and are also best avoided for reader comfort. Thus, in a separate subroutine 42, somewhat weak verbs are encircled in light green as a unique critical indicator. Somewhat weak verbs may be identified by reference to a lookup list.

Verbs not found to be weak or somewhat weak are considered strong verbs. Strong verbs add to reader comfort and warrant a commendatory indicator. Thus, in a separate subroutine 44, strong verbs are encircled in green. An alternative method for identifying strong verbs may be by reference to a strong verb list. This list may comprise, for example, verbs which add particular strength to business writing. Such a sample list is shown in the following Table 2:

TABLE 2
Strong Business Verb List

accept
address
advise
affirm
agree
analyze
appreciate
approach
appropriate
arrange
assist
augment
authorize
capture
collect
communicate
compile
compliment
concur
conduct
contrive
cooperate
coordinate
cultivate
define
denote
derive
describe
deserve
design
designate
determine
develop
drive
educate
emphasize
encourage
enhance
establish
evaluate
examine
exchange
expose
facilitate
factor
favor
find
focus
force
formulate
forward
gain
garner
gauge
glean
govern
gravitate
grow
guide
happen
harness
highlight
hinder
hold
identify
implement
improve
incorporate
initiate
instigate
institute
interact
juggle
justify
launch
lead
leverage
liken
manage
mediate
meet
meter
migrate
muster
obtain
offer
optimize
organize
parcel
participate
perform
plan
prepare
present
prevent
produce
propose
provide
qualify
quantify
query
question
range
rank
recognize
recommend
reiterate
report
require
resolve
restate
reveal
revise
serve
shape
span
sponsor
streamline
stress
study
submit
summarize
support
take
terminate
track
trust
value
verify
veto
voice
wield
work
yield

Words and phrases communicating transitions between thoughts from one sentence to the next generally add to reader comfort. However, transition words and phrases detract from reader comfort when placed between a subject and its logically-associated, corresponding verb. Thus, in a separate subroutine 46, transition words interposed between subject and verb are displayed with a unique critical indicator: yellow underlining Transition words may be identified with a lookup list such as that in the following Table 3:

TABLE 3
Transition Word List

accordingly
although
consequently
however
nevertheless

In yet a separate subroutine 48, words and phrases found in the transition word list, but not interposed between subject and verb, are given a unique commendatory indicator: blue underlining.

Prepositional phrases detract from reader comfort in a variety of ways. Thus, prepositional phrases will normally be displayed along with a critical indicator. However, certain placements and certain categories of prepositional phrases affect reader comfort differently, and therefore are displayed with different unique indicators. For example, where a job title precedes the preposition in a prepositional phrase, as in “president of the association,” an informational indicator may be displayed with the phrase, indicating that the phrase should be treated as an acceptable group noun. Any clear, unique highlighting or diacritical marking in the display will suffice, none being particularly preferred over any other. Such informational indicator may be displayed as the result of a separate subroutine 50. Or, alternatively, this special type of prepositional phrase may be displayed with no indicator at all, as this type does not generally cause the reader discomfort problems normally associated with other prepositional phrases.

In a separate subroutine 52, prepositional phrases which express location are displayed with a unique informational indicator when they appear in a string of three or more prepositional phrases. Any clear, unique highlighting or diacritical marking in the display will suffice, none being particularly preferred over any other. Strings of three or more prepositional phrases cause a monotonous, undesirable cadence, and are therefore best broken up. Frequently, an easy remedy is to move one of the prepositional phrases from the string to the beginning of the sentence. In making the choice of which to move forward, prepositional phrases expressing location are generally the best candidates. Thus, the display indicator applied by subroutine 52 informs the writer or editor that it is preferable to move the location-expressing prepositional phrase.

One of the most common causes of reader confusion and discomfort is placement of prepositional phrases between subjects and their logically associated verbs. Such interposing prepositional phrases usually result from using weak words to describe the actor or subject of the sentence, thus requiring further explanation or definition before the sentence's verb. Once identified, certain specific remedies can cure these problems. Therefore, in a separate subroutine 54, such interposing prepositional phrases are displayed with a unique critical indicator: yellow highlighting.

Business writers need to be aware of use and placement of all prepositional phrases, because they often cause clarity problems. Thus, except for those preceded by job titles, which through separate subroutine 50 are displayed with a mere informational indicator or no indicator at all, all prepositional phrases should be displayed with critical indicators. Yellow highlighting applied in subroutine 54 identifies a special, most comfort-decreasing type of prepositional phrase misuse. But, all other uses of prepositional phrases should be monitored, as well. Thus, in yet a separate subroutine 56, prepositional phrases not preceded by job titles are displayed with a unique critical indicator. Any clear, unique highlighting or diacritical marking in the display will suffice, none being particularly preferred over any other. However, as discussed farther below, it may simply be expedient to use the same gray highlighting employed in a separate routine 70. But, in any case, any marking or highlighting displayed as a result of subroutine 56 should be sufficiently distinct from that applied in subroutine 54, so both may be displayed at once.

As noted above, sentence constructions including three or more prepositional phrases in a row sound repetitious, and set up an uncomfortable, monotonous cadence. Thus, in addition to displaying prepositional phrases other than those preceded by job titles with critical indicators, a separate display subroutine 58 marks groups of three or more consecutive prepositional phrases. For maximum reader comfort, prepositional phrases preceded by job titles are included in the count because, although otherwise benign, they contribute to the undesirable cadence set up by lengthy prepositional phrase strings. Any clear, unique highlighting or diacritical marking in the display will suffice, none being particularly preferred over any other. And, such display indicator may be either a single mark or multiple marks; e.g. a single color of highlighting may be displayed over all of the prepositional phrases in the three-or-greater group, or each may be displayed with a separate diacritical mark. Further, each prepositional phrase in the group may be displayed with the critical indicator. But, in any case, any marking or highlighting displayed as a result of subroutine 58 should be sufficiently distinct from that applied in subroutines 52 and 56, so all may be displayed at once.

Interposing prepositional phrases between associated subjects and verbs negatively affects reader comfort in special ways; and, interposing transition words between subjects and verbs negates the normally beneficial use of transitions. Thus, these constructions are displayed with different critical indicators generated in subroutines 54 and 46, respectively. However, other words and word groups between associated subjects and verbs also negatively affect sentence clarity. Thus, in a separate subroutine 60, all words other than transitions and prepositional phrases interposed between associated subjects and verbs are displayed with a unique critical indicator. Any clear, unique highlighting or diacritical marking in the display will suffice, none being particularly preferred over any other. But, for convenience and without causing undue confusion for the writer, the same yellow underlining used in displaying interposing transition words may also be used here.

Despite interruptions between subject and verb being generally detrimental to reader comfort, one type of interposing word construction is generally acceptable, and perhaps even desirable. These are time-indicating adverbs such as always, never and rarely. Thus, an alternative form of subroutine 60 may refrain from displaying a unique indicator on time-indicating adverbs when these are placed between the subject and verb. And, yet a separate alternative subroutine may cause time-indicating adverbs to be displayed with a commendatory indicator.

Sentence constructions are of four different types: simple; compound; complex; and, compound-complex. Reader comfort is enhanced when a business text document includes a mix of these sentence-types. Separate subroutines cause a unique informational indicator to be displayed in connection with each type. For example, in one subroutine 62, a capital “S” in parentheses is displayed following each simple sentence, e.g. “(S).” In a second subroutine 64, “(Cd)” is displayed following compound sentences. In a third 66, “(Cx)” is displayed following complex sentences. And, in a fourth subroutine 68, “(Cd-Cx)” is displayed following each compound sentence having a complex subpart.

In a first single common indicator display routine 70 depicted in FIG. 2C, a group of writing blunders which diminish clarity in business documents are all displayed with a single, identical, unique critical indicator. That critical indicator is gray highlighting; it is applied in each of the following-described subroutines, none of which particularly needs to be carried out before the other, The gray highlighting applied in subroutines 72, 74, 76, 78 and 79 to follow is a critical indicator generally communicating to the writer that the text includes elements likely to be too wordy and therefore boring for the reader. The same indicator is applied to all of these undesirable constructs, without further distinguishing them from one another, as all have similar effects on business writing. However, if the method of the invention includes a chart, key or set of instructions such as that set forth in the table farther below, the writer will be instantly apprised of the problem communicated by gray highlighting.

In one subroutine 72, the word “There” is highlighted in gray if it appears at the beginning of a sentence. This warns that starting a sentence with “There” traps the writer into using a weak verb, thus causing problems throughout the sentence.

Starting a sentence with “It” causes similar problems. Thus, in a similar but separate subroutine 74, the word “It” is highlighted in gray if it appears first.

The word “responsible” anywhere in a sentence promotes the use of prepositional phrases, and words derived from verbs by adding the suffix “ing.” Both are best kept to a minimum in striving for reader comfort. Thus, in a separate subroutine 76, the word “responsible” appearing anywhere is displayed in gray highlighting.

Verb derived words ending in “ing” are boring. These derived noun forms of verbs are commonly referred to as gerunds. In subroutine 78, gerunds are displayed in gray highlighting. Subroutine 78 may include reference to a non-gerund “ing”-ending word lookup list, to assure that certain “ing”-ending words are not improperly displayed with the critical gray-highlighting indicator. Such a list is shown in Table 4:

TABLE 4
Non-gerund, “ing”-ending Word List

bring
ding
fling
king
ring
sing
thing
wing

As alluded to above in connection with prepositional phrase subroutine 56, it may also be expedient to use gray highlighting as the critical display indicator for all prepositional phrases, other than those preceded by job titles. This is not inconsistent with the general message conveyed to the writer by gray highlighting, i.e. that the highlighted constructs cause wordiness and risk boring the reader. Thus, using gray highlighting in displaying all but job title-type prepositional phrases is an optional alternative subroutine 79 in display routine 70.

In a second single common indicator display routine 80 depicted in FIG. 2D, the grammatical subjects of certain sentences in a paragraph are all displayed with a single, identical, unique informational indicator, permitting the writer to determine whether the paragraph has sufficient “unity.” That informational indicator is a diacritical mark, preferably a purple “X.” It is applied in each of the two following-described subroutines, neither of which particularly needs to be carried out before the other.

Paragraph unity refers to the way specific grammatical subjects relate to the paragraph topic in general. Greater paragraph unity exists when sentences following the paragraph's first include the same words or synonyms in subject position as the first. For example, when a particular actor appears as the grammatical subject in the first sentence of a paragraph, the same words describing that actor, or pronouns or synonyms therefor, should be in grammatical subject position in the majority of sentences throughout the paragraph. Paragraphs short on unity are perceived by the reader as constantly changing focus, and lacking coherence. A lack of paragraph unity risks making the reader feel jerked around, and confused.

Subroutines 82 and 84 permit the writer to assess paragraph unity. In subroutine 82, the informational purple X indicator is displayed along with the grammatical subject. In subroutine 84, a like informational indicator is displayed with the grammatical subject of any sentence having the same words in grammatical subject position as those in grammatical subject position in the paragraph's first sentence. A pronoun or other synonym for the words of the grammatical subject of the first sentence will also suffice, and will be similarly displayed with the informational purple X indicator. The more purple X's in a paragraph, the greater its unity and, consequently, the more comfortable it is to read.

The results of display indicator generation routine 30 and all of its subroutines 32-84 will be more useful to the writer if a key, chart or instructional list such as that set forth in Table 5 is provided in display or printed form.

TABLE 5
Key To Display Indicators

| Indicator: | Identifies: | Type: |
|---|---|---|
| SINGLE BLACK | Subject | Informational |
| UNDERLINE | | |
| DOUBLE BLACK | Verb in a sentence or clause. | Informational |
| UNDERLINE | | |
| PINK HIGHLIGHT | Subject and verb properly | Commendatory |
| | juxtaposed. | |
| ORANGE CHECK | Weak verb. | Critical |
| MARK | | |
| DARK GREEN CIRCLE | Strong verb. | Commendatory |
| LIGHT GREEN | Somewhat weak verb. | Critical |
| CIRCLE | | |
| YELLOW HIGHLIGHT | Prepositional phrase | Critical |
| | interposed between subject | |
| | and verb. | |
| YELLOW UNDERLINE | Transition words interposed | Critical |
| | between subject and verb. | |
| | (May also be used for other | Critical |
| | words interposed between | |
| | subject and verb.) | |
| GRAY HIGHLIGHT | There” at beginning of | Critical |
| | sentence. | |
| | “It” at beginning of | Critical |
| | sentence. | |
| | “Responsible” anywhere in | Critical |
| | sentence. | |
| | Gerunds, i.e. derived noun | Critical |
| | forms of verbs, ending in | |
| | “ing.” | |
| | (May also be used on | Critical |
| | prepositional phrases other | |
| | than those preceded by job | |
| | titles.) | |
| BLUE UNDERLINE | Transitional words (unless | Commendatory |
| | interposed between subject | |
| | and verb.) | |
| PURPLE X | Grammatical subject in a | Informational |
| | paragraph's first sentence. | |
| | Grammatical subject of any | Informational |
| | sentence of a paragraph after | |
| | the first, wherein the | |
| | grammatical subject is the | |
| | same as, or a synonym for, | |
| | the grammatical subject of | |
| | the first sentence. | |
| OTHER | Three or more propositional | Critical |
| INDICATORS | phrases in a row. | |
| OPTIONAL | Propositional phrases | Informational |
| INDICATORS | preceded by job titles. | |
| | Prepositional phrases | Informational |
| | expressing location. | |
| (S) | Simple sentence. | Informational |
| (Cd) | Compound sentence. | Informational |
| (Cx) | Complex sentence. | Informational |
| (Cd-Cx) | Compound-complex | Informational. |
| | sentence. | |

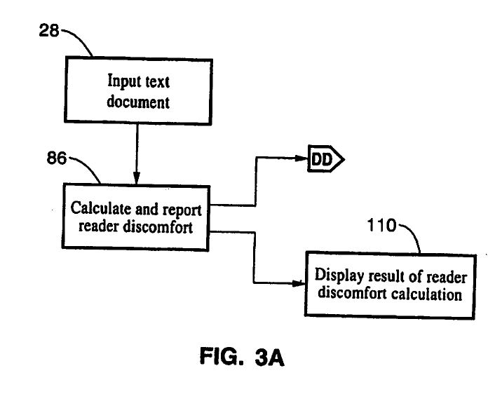

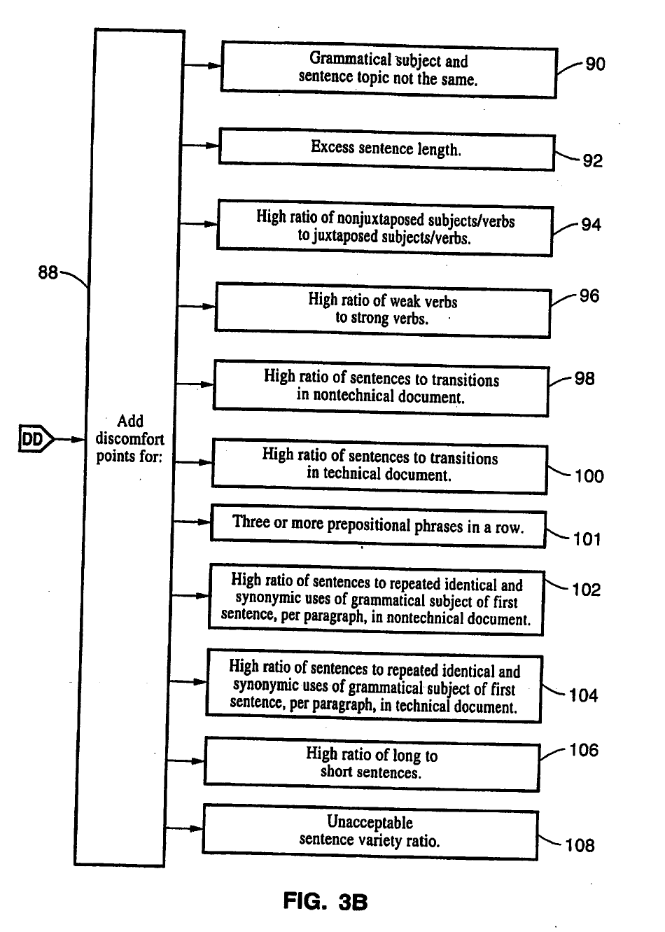

In a routine separate from that which generates display indicators 30, a routine may be run on computer system 10 wherein reader discomfort in a business text document 28 is calculated and reported 86. That is, through routine 86, reader discomfort may be quantified. See FIGS. 3A and 3B illustrating this second embodiment of the invention. Routine 86 may be run separately from, in any order with respect to, or even without, display indicator generation routine 30. However, as in routine 30, routine 86 may include parsing or otherwise analyzing each sentence of the document to identify all of its parts of speech and other components.

As shown in FIG. 3B, a first step 88 in reader discomfort calculating and reporting routine 86 comprises tallying discomfort points generated from several separate subroutines. No particular order need be followed in carrying out the calculating subroutines. And, any convenient conventional method may be employed for counting and tallying points upon completion of each subroutine. Those skilled in the art will envision many different point-counting and tallying systems, all of which are considered to be within the scope of the invention. And, the scoring methods set forth herein are by way of example only, and without limitation. Indeed, the method may not even necessarily include points, per se.

In the following subroutines 90 to 108, discomfort points are added for instances of unacceptable constructions, and for unacceptable ratios of instances of unacceptable constructions to instances of acceptable constructions. Points may be added to an initial baseline score, for example, “zero.” Maximums, minimums, ratios and permissible ranges applied may be predetermined, or set by a writer or editor using the inventive method.

In a first subroutine 90, a count is taken of instances wherein the topic of a sentence is not the same as its grammatical subject. The greater number of instances of such disagreement, the greater the reader discomfort and, therefore, the greater number of discomfort points.

In a separate subroutine 92, the number of words in each sentence of a business document is counted. Discomfort points may be generated by the average sentence length exceeding a predetermined maximum, or by an individual sentence exceeding the maximum. The length maximum may be different for different types of documents, e.g. for more or less technical writing. And, the length maximum may be adjustable by the writer or editor.

In a separate subroutine 94, the number of instances of nonjuxtaposed subjects and verbs is compared with the number of instances of properly juxtaposed subjects and verbs. A high ratio of the former to the latter yields a greater number of discomfort points.

In a separate subroutine 96, the number of weak verbs is compared with the number of somewhat weak verbs and strong verbs used. Somewhat weak verbs are counted as strong verbs in this subroutine. A high ratio of weak to strong verbs yields a greater number of discomfort points. Subroutine 96 may include reference to lookup lists such as those set forth in Tables 1 and 2.

In a separate subroutine 98, the number of transitional words in a business document is counted and compared with the number of sentences in the document. A high ratio of sentences to transition words makes reader discomfort likely, and therefore yields a greater number of discomfort points. Subroutine 98 may include reference to a lookup list such as that set forth in Table 3.

Reader discomfort caused by a high sentence to transition word ratio may be relative to the technical content of the document. That is, readers of more technical documents may tolerate higher sentence to transition ratios. Therefore, in a separate subroutine 100, fewer discomfort points are generated by documents having fewer sentence to sentence transitions. This may be adjustable by the writer or editor.

As noted in connection with subroutine 58, sentences having three or more prepositional phrases in a row reduce reading comfort. Thus, in subroutine 101, discomfort points are added when such prepositional phrase strings appear in the document.

In a separate subroutine 102, individual paragraphs are analyzed for unity. Thus, the grammatical subject of the first sentence is noted, and then the other sentences in the paragraph are analyzed to determine whether their grammatical subjects are the same as, or synonymous with, the grammatical subject of the first. A high ratio of sentences to repeated appearances of the first sentence's grammatical subject makes reader discomfort more likely, and therefore yields a greater number of discomfort points.

Reader discomfort caused by a high sentence to grammatical subject-repeat ratio may be relative to the technical content of the document. That is, readers of more technical documents may tolerate higher sentence to grammatical subject-repeat ratios. Therefore, in a separate subroutine 104, fewer discomfort points are generated by documents having higher sentence to grammatical subject-repeat ratios. This may be adjustable by the writer or editor.

In a separate subroutine 106, the ratio of long sentences to short sentences is calculated. A high ratio of the former to the latter yields a greater number of discomfort points. Ideal limits may be different for different types of documents, e.g. for more or less technical writing. And, limits may be adjustable by the writer or editor. This subroutine may be carried out with, or use some of the same calculations as, subroutine 92.

In a separate subroutine 108, the ratio of simple sentences to compound sentences to complex sentences to compound-complex sentences is calculated. Ideal ratio ranges are highly dependent upon many factors, including the length of the document, the subject matter being communicated and the intended audience. Ideal ranges are preferably adjustable by the writer or editor.

Once subroutines 90 through 108 have been completed, and the discomfort points in the document have been tallied, the relative discomfort a reader will feel in reading a document can effectively be quantified. Routine 110 displays the result of the tally. Display may be, for example, on display terminal 24. Alternatively, a hard copy of the display may be generated, if desired.

In one alternative display mode, a single score is reported. In another alternative display mode, a separate score is reported for the result of each subroutine. And, in yet an alternative manner of running calculating and reporting routine 86, commendatory points may be additionally or alternatively tallied for desirable, comfort-enhancing constructions such as those set forth in connection with indicator display generation routine 30.

Routine 86 and all of its subroutines may be portions of software module 26, or they may be constructed as separate software modules.

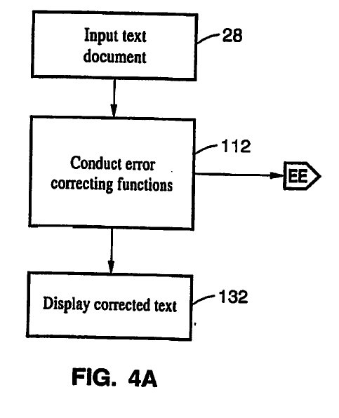

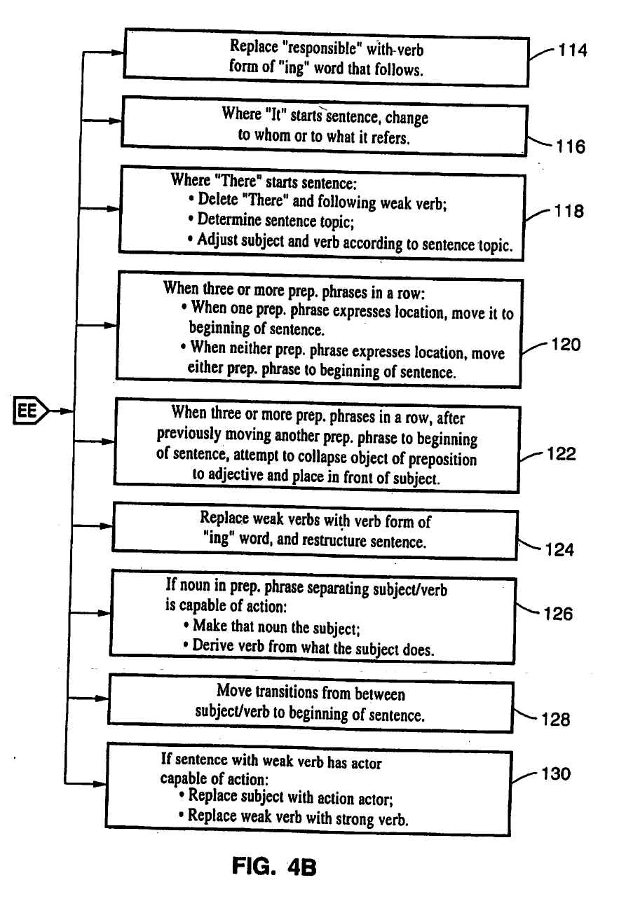

In a routine separate from that which generates display indicators 30, and separate from that which calculates and reports reader discomfort 86, a routine 112 may be run wherein error-correcting, i.e. editing, functions are carried out. See the flow chart of FIGS. 4A and 4B illustrating this third embodiment of the invention. Routine 112 proceeds from text document input 28. Routine 112 may be run separately from, in any order with respect to, or even without, routines 30 and 86. However, routine 112 is adapted to run in conjunction with those routines, on computer system 10.

Routine 112 includes several discrete subroutines adapted to remedy particular common problems in business writing. No specific order need be followed in carrying out these editing subroutines. And, there are many possible alternative modes for carrying them out. For example, editing may be interactive, including one or more rounds of display and input-accepting functions requiring a writer's or editor's input or assent. Or, the editing may be more of a batch process, wherein the entire group of subroutines is run on the document before delivering the result. Such result may be a fully-edited document, or a document with results of the editing subroutines interlineated throughout the original text. For example, the inventive method may employ standard word processor-like editing methods, such as producing a redline-strikeout version of the document, i.e. wherein suggested or completed additions appear in highlighted text, and suggested or completed deletions appear stricken over with dashes. Ideally, any editing mode herein would also include use of the display indicators generated in routine 30. And, the calculating and reporting functions of routine 86 may be employed in editing, as well.

In yet another alternative mode, the editing subroutines may be applied word by word, Le. “on the fly,” during drafting. Thus, while the writer is composing, errors are being fixed, suggestions are being made, and choices, answers and other input are being requested. Other optional ways of employing the editing subroutines herein will be understood by those having skill in the art.

Comparing the steps in the following subroutines with one another should make it clear that some of the subroutines may safely be relatively automatic, while others will require some interactively-applied judgment from the writer or editor to render the best written product. However, as capabilities of language processing software improve to the point, for example, where the software can make reliable editing choices based on context and meaning drawn from adjacent words, sentences and paragraphs, then less input from the writer or editor will be necessary.

As shown in FIG. 4B, one subroutine 114 comprises replacing the word “responsible,” wherever found, with the verb form of the “ing” word which nearly inevitably follows. This subroutine may include reference to a lookup list such as that set forth in Table 4, and/or to a list of acceptable constructions including the word “responsible.” Running subroutine 114 removes boring “ing” words and results in the use of stronger verbs, thus making the content of the document more memorable.

In a separate subroutine 116, whenever the word “It” appears at the beginning of a sentence, it is replaced with a more descriptive noun for the person or thing for which “It” is acting as a pronoun. Making this replacement guides the writer toward using stronger verbs, and results in making the writing more interesting.

In a separate subroutine 118, when the word “There” starts a sentence, a three-step procedure is carried out to remove that faulty construction's deleterious effects on reader comfort. First, the word “There” and its inevitably-following weak verb are deleted. Next, the topic of the sentence is determined. And finally, the subject and verb of the sentence or clause are adjusted or re-chosen in accordance with the sentence topic. An interactive mode of editing is expected to yield the best written product from this subroutine. For example, the writer may be presented with several alternately-worded versions of the restructured sentence, and then given the opportunity to choose one.

In a separate subroutine 120, a multi-step procedure is carried out when three or more prepositional phrases appear in a row. The problems caused by strings of prepositional phrases are discussed above in connection with subroutines 58 and 101. The simplest remedy for those problems is to move one of the prepositional phrases to the beginning of the sentence. This breaks up the lengthy chain of phrases, and permits one to serve as an introductory phrase. However, different types of prepositional phrases have different effects on reader comfort. For example, in routine 120, if one of the prepositional phrases expresses location, that is the one which will be moved to the beginning of the sentence. That serves reader comfort best. Alternatively, if location is not expressed by any of the prepositional phrases in the string, the writer may have the option of moving any one of the string forward. That option is likely best presented through an interactive mode of editing.

If, after moving one prepositional phrase to the beginning of the sentence, three or more in a row nevertheless remain, a separate subroutine 122 attempts to collapse the object of the preposition in each phrase to an adjective, and to place that adjective in front of the subject. If that can be successfully done, the number of prepositional phrases is reduced, and reader comfort is enhanced. Interactive editing may be employed to give the writer or editor choices among the phrases able to be collapsed.

In yet a separate subroutine 124, in sentences having both weak verbs and “ing” words derived from verbs, the weak verbs are replaced with the verb form of the “ing” word, and the sentence is restructured to read properly. Subroutine 124 may include reference to weak verb and “ing” word lookup lists such as those set forth in Tables 1 and 4. An interactive mode of editing is preferred in subroutine 124, because the final restructuring of the sentence may require some judgment to yield the best result.

When a prepositional phrase splits an associated subject and verb, subroutine 126 provides a remedy if the noun in the prepositional phrase is capable of action. In that instance, subroutine 126 makes the noun the subject of the sentence, and then a substitute verb is derived from what the subject does. An interactive mode of editing is preferred in subroutine 126, because judgment exercised in deriving the verb will likely yield the best written product.

In a separate subroutine 128, each transitional word interposed between a subject and its associated verb is moved to the beginning of the sentence, This enhances paragraph unity, as discussed in connection with subroutines 82 and 84. Subroutine 128 may include reference to a transition word lookup list such as that set forth in Table 3.

When a sentence has a weak verb, subroutine 130 can provide a remedy if the sentence also has an actor capable of action. In that instance, subroutine 130 replaces the subject of the sentence with the action-capable actor, and replaces the weak verb with a strong verb. Subroutine 128 may include reference to weak verb and strong verb lookup lists such as those set forth in Tables 1 and 2. An interactive mode of editing is expected to yield the best written product from subroutine 128, because making the proper verb choice involves some judgment.

Once editing is complete, an edited form of the text document is displayed 132. The display mode is dependent upon the editing mode employed. Display may be word by word during drafting if an “on the fly” editing mode is employed. Or, if editing a completed document, display may be error by error, subroutine by subroutine, sentence by sentence, paragraph by paragraph or in any other manner convenient to a writer or editor. And, the display may be in the form of a hard copy, as well.

Routine 112 and all of its subroutines may be portions of software module 26, or they may be constructed as separate software modules.

The foregoing detailed disclosure of the inventive methods and computer system 10 are considered only illustrative of the preferred embodiments of, and not limitations upon the scope of, the invention. Those skilled in the art will envision many other possible variations of the structure disclosed herein that nevertheless fall within the scope of the following claims. For example, the word lists set forth herein should not be considered limiting. Many words and phrases may be added to each of the lists, or may be removed, as well, without departing from the spirit of the invention. And, additional lists may also be employed.

Further, although the method is expected to be best carried out by processing an electronic document, i.e. a document stored or delivered via an electronic medium, the method may also be applied to a document printed or otherwise displayed on a planar, non-electronic display medium, such as paper. In that case, the highlighting and diacritical markings of the invention may be applied directly to the planar medium on which the document is displayed.

And, alternative uses for this inventive method and apparatus may later be realized. Accordingly, the scope of the invention should be determined with reference to the appended claims, and not by the examples which have herein been given.

We claim:

1. A method for style-checking an electronic text document to achieve clarity, conciseness and reader comfort, comprising the steps of:
a. inputting a document to a computer system;
b. parsing the sentences of said document;
c. displaying a commendatory indicator on a computer display terminal if a subject and corresponding verb of a sentence or clause in said document are juxtaposed;
d. displaying a critical indicator on a computer display terminal if said subject and verb are not juxtaposed;
e. displaying a critical indicator on a computer display terminal if said document includes a prepositional phrase;
f. displaying a commendatory indicator on a computer display terminal if said document includes a strong verb;
g. displaying a critical indicator on a computer display terminal if said document includes a weak verb; and
h. displaying said document on a computer display terminal with said indicators.

2. The method of claim 1, wherein the step of displaying a commendatory indicator if said subject and verb are juxtaposed comprises highlighting said subject and verb in a unique color.

3. The method of claim 1, wherein the step of displaying a critical indicator if said subject and verb are not juxtaposed comprises highlighting a word interposed between said subject and verb in a unique color.

4. The method of claim 1, wherein the step of displaying a critical indicator if said document includes a prepositional phrase comprises highlighting said prepositional phrase with a color indicating an undesirable construction.

5. The method of claim 1, wherein the step of displaying a critical indicator if said document includes a prepositional phrase is carried out for all prepositional phrases except those which express location.

6. The method of claim 1, wherein the step of displaying a commendatory indicator if said document includes a strong verb comprises displaying a diacritical mark with said strong verb.

7. The method of claim 1, wherein the step of displaying a commendatory indicator if said document includes a strong verb includes referring to a verb lookup list.

8. The method of claim 1, wherein the step of displaying a critical indicator if said document includes a weak verb comprises displaying a diacritical mark with said weak verb.

9. The method of claim 1, wherein the step of displaying a critical indicator if said document includes a weak verb includes referring to a verb lookup list.

10. The method of claim 1, further comprising the step of displaying a subject of a sentence or clause in said document with an informational indicator.

11. The method of claim 10, wherein the step of displaying a subject with an informational indicator comprises displaying said subject with an underline.

12. The method of claim 1, further comprising the step of displaying a verb in said document with an informational indicator.

13. The method of claim 12, wherein the step of displaying a' verb with an informational indicator comprises displaying said verb with a double underline.

14. The method of claim 1, further comprising the step of displaying a commendatory indicator if said document includes a transition word.

15. The method of claim 14, wherein the step of displaying a commendatory indicator if said document includes a transition word includes referring to a transition word lookup list.

16. The method of claim 1, further comprising the step of displaying a critical indicator if a sentence includes a string of three or more prepositional phrases in a row.

17. The method of claim 22, further comprising the step of displaying an informational indicator if a prepositional phrase in said string expresses location.

18. The method of claim 1, further comprising the step of displaying an informational indicator if a sentence in said document is a simple sentence.

19. The method of claim 1, further comprising the step of displaying an informational indicator if a sentence in said document is a compound sentence.

20. The method of claim 1, further comprising the step of displaying an informational indicator if a sentence in said document is a complex sentence.

21. The method of claim 1, further comprising the step of displaying an informational indicator if a sentence in said document is a compound-complex sentence.

22. The method of claim 1, further comprising the step of displaying a critical indicator if said document includes a gerund.

23. The method of claim 22, wherein the step of displaying a critical indicator if said document includes a gerund includes referring to a non-gerund “ing”-ending word lookup list.

24. The method of claim 22, wherein the step of displaying a critical indicator if said document includes a gerund comprises highlighting said gerund with a color indicating an undesirable construction.

25. The method of claim 1, further comprising the step of displaying a critical indicator if said document includes a sentence starting with the word “There.”

26. The method of claim 25, wherein the step of displaying a critical indicator if said document includes a sentence starting with the word “There,” comprises highlighting the word “There” with a color indicating an undesirable construction.

27. The method of claim 1, further comprising the step of displaying a critical indicator if said document includes a sentence starting with the word “It.”

28. The method of claim 27, wherein the step of displaying a critical indicator if said document includes a sentence starting with the word “It,” comprises highlighting the word “It” with a color indicating an undesirable construction.

29. The method of claim 1, further comprising the step of displaying a critical indicator if said document includes the word “responsible.”

30. The method of claim 29, wherein the step of displaying a critical indicator if said document includes the word “responsible,” comprises highlighting the word “responsible” with a color indicating an undesirable construction.

31. The method of claim 1, further comprising the steps of
i. displaying an informational indicator with the grammatical subject of the first sentence of each paragraph of said document; and,
ii. displaying said same informational indicator with each grammatical subject of each additional sentence in said paragraph wherein said grammatical subject is the same as, or synonymous with, said grammatical subject of said first sentence.

32. The method of claim 1, wherein each of said indicators is a different color.

33. Apparatus capable of carrying out the method of claim 1.
